(19) United States
(12) Patent Application Publication
(10) Pub. No.: US 2017/0335643 A1
(43) Pub. Date: Nov. 23, 2017

(54) DRILLING SYSTEM USING DRILL BEADS AND METHOD OF USING AND RECOVERING THE SAME

(71) Applicant: Barrett Allen, Denver, CO (US)

(72) Inventor: Barrett Allen, Denver, CO (US)

(21) Appl. No.: 15/498,147

(22) Filed: Apr. 26, 2017

Related U.S. Application Data
(60) Provisional application No. 62/328,382, filed on Apr. 27, 2016.

(51) Int. Cl. E21B 21/06; B03B 5/44; E21B 21/00

(52) U.S. Cl. CPC E21B 21/065; B03B 5/442; E21B 21/00; B07B 2230/01

(57) ABSTRACT

A method to recover drill beads from a drilling fluid used in a drilling operation comprising the steps of: directing a drilling fluid containing drill beads into a drill string positioned in a well bore, the drill beads having magnetic properties; recovering the drilling fluid containing at least a portion of the drill beads from the well bore; and magnetically separating the drill beads from the drilling fluid.

### CROSS-REFERENCE TO RELATED APPLICATIONS

The present patent application claims priority to and hereby incorporates by reference the entire provisional patent application identified by U.S. Ser. No. 62/328,382, filed on Apr. 27, 2016.

### BACKGROUND

It is common in drilling industries to use a drilling fluid, also called drilling mud, as a lubricant during drilling operations, such as drilling oil wells, drilling natural gas wells, and in exploration drilling rigs.

Drilling fluids perform various functions when implemented during a drilling operation. For instance, drilling fluids can provide any of the following functions:

remove cuttings from the well

assist in the control of formation pressures

suspend and release cuttings

seal permeable formations

assist in maintaining wellbore stability

minimize formation damage

cool, lubricate and support the bit and drilling assembly

transmit hydraulic energy to downhole tools and bit

ensure adequate formation evaluation

control corrosion to acceptable levels

facilitate cementing and completion

minimize environmental impact

During a drilling operation, there are a number of factors to consider when selecting the proper drilling fluid for a particular well. The cost, availability of specific products, and environmental impact are examples of factors taken into account when choosing a drilling fluid. The properties of different drilling fluids are also taken into account when selecting a drilling fluid. The different properties of the drilling fluid can affect the desired functions of the drilling fluid. The effects on the desired functions must be realized and the drilling fluids must be designed taking into account their influence on all functions as well as the relative importance for each function.

Various additives, such as thinners, fluid loss control agents, corrosion inhibitors, weight materials, clays, drill beads, and lost circulation materials, can be added to develop drilling fluids having specific properties to target some of the specific functions listed above. Generally, these additives are introduced at the drill site in various combinations designed to address the specific requirements of the bore being drilled.

Generally, drilling fluids are pumped through a drill string, out of the drill string, and across the drill bit to clean and cool the drill bit. The drilling fluid then travels back up an annular space between the drill string and the sides of the hole being drilled in the formation. As the fluid travels up, the drilling fluid will eventually enter the annulus between the drill string and the surface casing and ultimately emerge at the surface. Once the drilling fluid has emerged from the surface, the cuttings can be removed and the drilling fluid can be stored and/or recycled back into the drill string.

Drill Beads reduce friction at points of contact between the drill string and any surface the drill string may come into contact with within the wellbore. This reduced friction allows force to be transferred to the bit, which is desirable, instead of being lost at the friction points. Drill Beads are generally made out of ceramic, glass, plastic, graphite, carbon, and carbon fiber.

In the past, there has not been a way to effectively recover drill beads which were pumped into a wellbore which increases costs significantly. When drilling fluid is recovered at the surface, it is processed to remove the drill cuttings. When removing the drill cuttings from the drilling fluid, it is difficult to differentiate between the drill cuttings and the drill beads still contained in the drilling fluid. Thus, the drill beads are generally removed along with the drill cuttings and have to be replaced with new drill beads. In the alternative, both the drill cuttings and the drill beads are left in the recovered drilling fluid and recycled back into the drill string. Over time, this causes a build-up of the drill cuttings and the drill beads in the drilling fluid and increases in the weight of the drilling fluid, which causes several negative effects on the well bore while drilling.

Accordingly, there exists a need for a drilling system and method capable of effectively using drill beads while reducing costs by efficiently recovering the drill beads. The inventive concepts disclosed herein are directed to such a drilling system and to a method of using the same.

### BRIEF DESCRIPTION OF THE DRAWINGS

FIG. 1 is a partial side elevational view and partial block diagram of a drilling fluid system in accordance with the presently disclosed inventive concepts.

FIG. 2 is a partial side elevational view of a mud pit containing a drilling fluid having a predetermined amount of drill beads introduced therein in accordance with one embodiment of the presently disclosed inventive concepts.

FIG. 3 is a flow diagram of steps of an embodiment of a method of using and recovering drill beads using the drilling fluid system of FIG. 1 in accordance with one embodiment of the presently disclosed inventive concepts.

FIG. 4 is a sectional view of a drill bead having pockets containing a predetermined amount of gas or liquid and a core having magnetic properties in accordance with one embodiment of the presently disclosed inventive concepts.

FIG. 5 is a sectional view of a drill bead having particles having magnetic properties infused in a shell material and a core filled with a gas or a liquid in accordance with one embodiment of the presently disclosed inventive concepts.

### DETAILED DESCRIPTION OF EXEMPLARY EMBODIMENTS

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

As used herein, the term “drilled solids” refers to pieces of formation that are the result of the chipping and/or crushing action of the drill bit during the drilling and excavation process.

As used herein, the term “magnet” refers to a particular element, feature, or structure which generates or is surrounded by a magnetic field and that has the property, either naturally or induced, of attracting other objects having magnetic properties or aligning itself in an external magnetic field. As used herein, a magnet may be a permanent magnet, a temporary magnet, or an electromagnet.

As used herein, any reference to “magnetic property” or “magnetic properties” means that a particular element, feature, structure, or characteristic described is capable of being at least temporarily magnetized or attracted by a magnet.

As used herein, the term “drilling fluid” or “drill fluid” refers to circulating fluid used in rotational drilling to perform various functions during drilling operations.

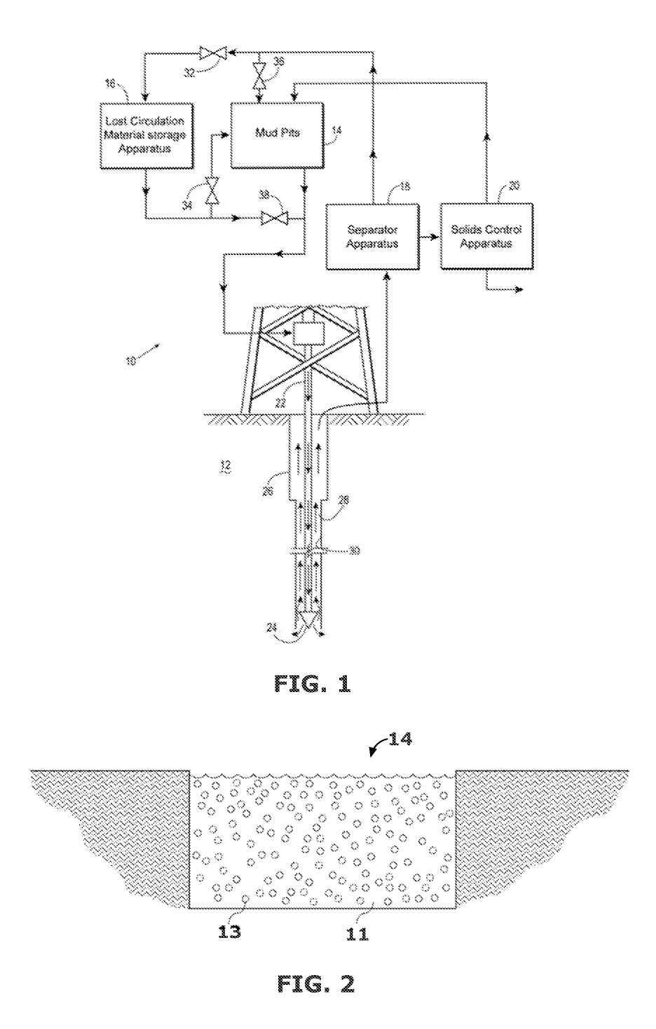

Referring now to the figures, and in particular to FIGS. 1 and 2, shown therein is a drilling fluid system 10 for providing a drilling fluid 11 containing drill beads 13 to a subterranean formation 12. In one embodiment, the drilling fluid system 10 is provided with a mud pit 14, a drill bead storage apparatus 16, a separator apparatus 18, a solids control apparatus 20, a drill string 22, a drill bit 24, a wellbore 26, an annulus 28, a wall 30, and a plurality of valves 32, 34, 36, and 38 to selectively control the path and storage location of the drill beads 13.

In one embodiment of the drill fluid system 10, drill beads 13 are added to the drilling fluid 11 to reduce the torque and drag associated with friction between the drill string 22 and the subterranean formation 12. The drilling fluid 11 collected at the surface, commonly known as spent drilling fluid, contains partial amounts of the drill beads 13 as well as drill cuttings collected downhole. As will be explained below, the drill beads 13 of the drilling fluid system 10 are designed such that they can be substantially recovered from the spent drilling fluid separately from the drill cuttings.

The drill beads 13 possess characteristics that render them distinguishable from the drill cuttings, thus allowing the drill beads 13 to be separated from the drill cuttings. For example, in one embodiment the drill beads 13 may be constructed of a material having magnetic properties. In another embodiment, the drill beads 13 may be formed using particles of material having magnetic properties infused throughout a shell material. By way of non-limiting example, the shell material may be any suitable material known in the art such as, for instance, synthetic polymers such as nylon or other aliphatic or semi-aromatic polyamides polymeric material, graphite, carbon, carbon fiber, or glass. In other embodiments, the drill beads 13 may be formed of material having magnetic properties that is partially, completely, or combinations thereof encapsulated in a shell material.

It should be noted, by way of non-limiting example, that the material having magnetic properties can be any ferromagnetic or paramagnetic material such as, for instance, portions of iron (ferrous), nickel, cobalt, steel, ferrite, hematite, or combinations thereof. The size of the drill beads 13 may be between substantially 1 micron and substantially 1 inch in diameter. The constituent particles having magnetic properties may be proportionately sized and may be in a range from substantially 0.01 micron to substantially 100 microns. The drill beads 13 and/or the particles having magnetic properties can be spherical, cylindrical, discoidal, tubular, ellipsoidal, equant, irregular, or combinations thereof.

A predetermined amount of the drill beads 13, based on the subterranean formation 12 and/or drilling parameters are added to the drilling fluid 11 prior to being introduced into a drilling operation. As used herein, the predetermined amount of the drill beads 13 refers to a concentration of drill beads 13 between 0.1 pounds per barrel (ppb) and 200 ppb. As used herein, ppb means pounds of drill beads 13 per oil field barrel which has a volume of 42 gallons.

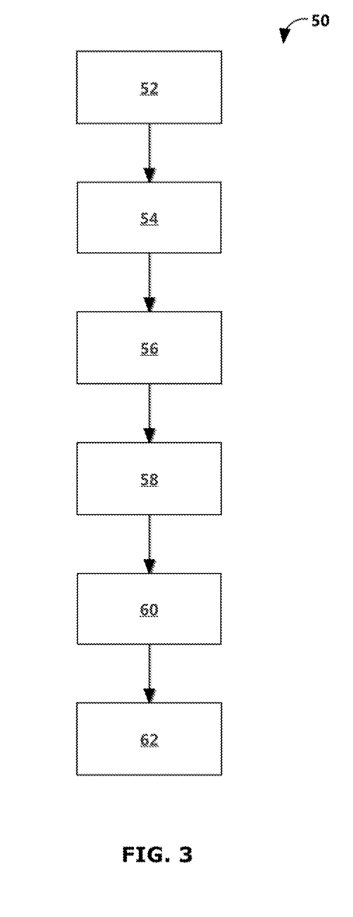

Referring now to FIG. 3, a flow diagram of the steps of a method 50 of using and recovering the drill beads 13 using the drilling fluid system 10 of FIGS. 1 and 2 comprises steps 52-62, which will be discussed in detail below.

Step 52 of the method 50 comprises introducing a predetermined amount of the drill beads 13 into the drilling fluid 11 prior to introducing the drilling fluid 11 into the drill string 22. Generally, drilling fluid 11 is stored and prepared in mud pit 14 while the drill beads 13 are stored separately in the drill bead storage apparatus 16. In one embodiment, the drill bead storage apparatus 16 may be a hopper configured to precisely control the timing and amount of drill beads 13 to be added to the drilling fluid 11. In another embodiment (not shown), the drilling fluid system 10 may be provided having a hopper (not shown) for adding drill beads 13 to the drilling fluid 11 while drill beads 13 that have cycled through the drilling fluid system 10 are stored in drill bead storage apparatus 16 to be added back into the drilling fluid 10 as will be described further herein. It should be appreciated, that while the drilling fluid 11 is described herein as being stored in mud pit 14, the drilling fluid 11 can be stored and prepared in any container or apparatus capable of storing a necessary amount of drilling fluid 11 for a particular drilling operation.

The introduction of the drill beads 13 into the drilling fluid 11 can be accomplished by opening the valve 34 and passing the drill beads 13 through valve 34 into the mud pit 14, in any suitable container (not shown), or on-the-fly by introducing the drill beads 13 into the drilling fluid 11 through valve 38 as the drilling fluid 11 is being introduced to the subterranean formation 12. In another embodiment (not shown), the drilling fluid system 10 may be provided having multiple drill bead storage apparatus' 16 each configured to introduce drill beads 13 having different sizes, shapes, or specific gravities each of which may be introduced into the drilling fluid 11 through different valves 34 to achieve a desired mixture. In another embodiment (also not shown), drill bead storage apparatus 16 may be a hopper configured to introduce a predetermined mixture of drill beads 13 directly into the mud pit 14 or the drilling fluid 11 on-the-fly without valves 34 or 38. In another embodiment (also not shown), the dill beads 13 may be provided in sacks containing a predetermined amount of drill beads 13 that may be emptied directly into the mud pit 14 by a rig worker in quantities necessary to reach a predetermined mixture of the drill beads 13 in the drilling fluid 11. It should be understood that the descriptions provided herein are for illustration purposes only and that various changes may be made to the way drill beads 13 are introduced into the drilling fluid 11 which will readily suggest themselves to those skilled in the art and which are accomplished within the scope and coverage of the inventive concepts disclosed and claimed herein.

The drilling fluid 11 containing the predetermined amount of drill beads 13 is introduced into the well bore 26 via the drill string 22 as shown in step 54. Once the drilling fluid 11 containing the drill beads 13 has been prepared, the drilling fluid 11 is introduced into the well bore 26 via the drill string 22. The drilling fluid 11 is directed through the drill string 22 and out of the drill bit 24 into the annulus 28 between the drill string 22 and the wall 30 of the well bore 26 and up toward the surface. After exiting the drill string 22 and while being forced up toward the surface, the drilling fluid 11 contacts drill cuttings created by drilling and transports them to the surface. As the drilling fluid 11 containing the drill beads 13 passes up through the annulus 28, at least a portion of the drill beads 13 contact the drill string 22 and the subterranean formation 12. The drill beads 13 function to reduce friction at points of contact between the drill string 22 and any surface the drill string 22 may come into contact with within the wellbore 26. This reduced friction allows force to be transferred to the drill bit 24, which is desirable, instead of being lost at the friction points.

In another embodiment, the drilling fluid 11 containing the predetermined amount of drill beads 13 is directed through the drill string 22 as described above and exits the drill string 22 before the drill bit 24 through at least one aperture (not shown) that has been cut, formed, or molded into the drill string 22. The drilling fluid 11 containing the predetermined amount of drill beads 13 then enters the annulus 28 between the drill string 22 and the wall 30 of the well bore 26 and is directed up toward the surface.

In another embodiment, the drilling fluid 11 containing the predetermined amount of drill beads 13 is introduced into the well bore 26 before passing down the annulus 28 and entering the drill string 22 where the drilling fluid 11 containing the predetermined amount of drill beads 13 is directed up to the surface in a process known as “reverse circulation.”

In step 56, the spent drilling fluid containing the drill beads 13 and the drill cuttings is captured at the surface and directed to the separation tank 18 where the drill beads 13 are separated from the spent drilling fluid and the drill cuttings.

The separator apparatus 18 is configured to remove substantially all of the drill beads 13 from the spent drilling fluid while leaving substantially all of the drill cuttings in the spent drilling fluid. In different embodiments, the separator apparatus 18 may comprise a wet drum magnet, magnetic conveyor belt, magnetic plate, immersion magnet, magnetic auger, and a magnetic centrifuge, or any other apparatus capable of separating particles having magnetic properties from a non-magnetic fluid.

In step 58, the drill beads 13 recovered from the spent drilling fluid can be reintroduced into the drilling fluid 11 in the mud pits 14, or stored in the storage apparatus 16 so that the drill beads 13 can be added to the drilling fluid 11 at a later time. As shown in FIG. 1, the recovered drill beads 13 are either directed via the valve 32 to the drill bead storage apparatus 16, or via valve 36 to the mud pit 14.

Step 60 comprises removing the drill cuttings from the spent drilling fluid by passing the spent drilling fluid from the separator apparatus 18 to the solids control apparatus 20 where the drill cuttings are separated from the spent drilling fluid. The solids control apparatus 20 can be any suitable apparatus known in the art capable of removing drill cuttings from spent drilling fluid such as, for instance, a shale shaker. Once separated in the solids control apparatus 20, the drill cuttings are discarded in any suitable manner known in the art.

In step 62, the spent drilling fluid having the drill cuttings removed is returned to the mud pit 14 to be reintroduced into the well bore 26.

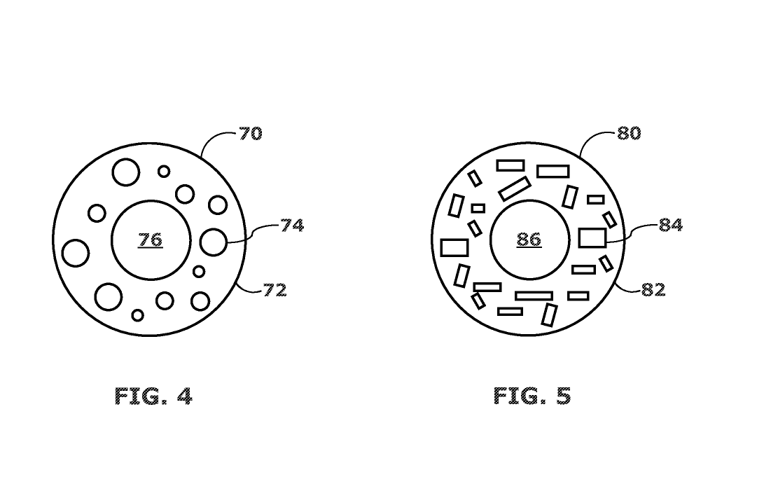

Referring now to FIG. 4, in one embodiment drill beads 70 may be provided with an outer shell 72, pockets 74 (only one of which is labeled in FIG. 4), and a core 76 having magnetic properties.

In one embodiment of the drill beads 70, the outer shell 72 may be formed of a synthetic polymer such as, for instance, nylon or other aliphatic or semi-aromatic polyamides.

In one embodiment of the drill beads 70, the pockets 74 may be filled with a gas such as, for instance, nitrogen. In another embodiment, the pockets 74 may contain a liquid such as, for instance, toluene or chlorine. In these embodiments, the pockets 74 may be formed in the outer shell 72 by introducing the gas or liquid during a mixing process when the synthetic polymer is in a liquid form. The gas or liquid infused synthetic polymer may then be formed concentrically surrounding the core 76 to form the drill bead 70.

In another embodiment shown in FIG. 5, drill beads 80 may be provided having an outer shell 82 infused with particles having magnetic properties 84 (only one of which is labeled in FIG. 5) surrounding a core 86.

In one embodiment of the drill beads 80, the core 86 may be filled with a gas such as, for instance, nitrogen. In such an embodiment, the gas may be introduced into the core 86 of the drill beads 80 during a mixing process as a liquid mixture of synthetic polymer infused with particles having magnetic properties 84 is formed to make the outer shell 82. Alternately, the gas may be introduced into the core 86 after the outer shell 82 infused with the particles having magnetic properties 84 has already been formed.

In another embodiment, the core 86 of drill beads 80 may be filled with a liquid such as, for instance, toluene or chlorine. In such an embodiment, the liquid may be introduced into the core 86 of the drill beads 80 during a mixing process as a liquid mixture of synthetic polymer infused with particles having magnetic properties 84 is formed to make the outer shell 82. Alternately, the liquid may be introduced into the core 86 after the outer shell 82 infused with the particles having magnetic properties 84 has already been formed.

Referring now to FIGS. 4 and 5, in practice drill beads 70 or 80 having gas or liquid contained in pockets 74 or the core 86 with different densities may be used to target specific areas of a well bore. For instance, drill beads 70 or 80 containing nitrogen may be used to target friction areas near the top of the well bore while drill beads 70 or 80 containing chlorine, which have a higher relative density, may be used to target friction areas near the bottom of the well bore.

It should be noted that a combination of drill beads 70 or 80 containing gases and/or liquids having different densities may be used to target the desired friction areas for a specific drill site. By way of non-limiting example, for a drill site having a first friction area near the top of the well bore and several friction areas near the bottom of the well bore, a mixture having 20% nitrogen filled drill beads 70 or 80 and 80% chlorine filled drill beads 70 or 80 may be used. Because the drill beads 70 or 80 filled with chlorine have a higher relative density, more of the drill beads 70 or 80 will be directed to the bottom of the well bore where there are more friction areas.

It should be noted that the gases and liquids referred to herein as used to fill the pockets 74 or the core 86 of drill beads 70 or 80 are referred to by way of non-limiting example only, and any suitable gas or liquid may be used to attain the advantages mentioned herein as well as those inherent in the inventive concepts disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the scope and coverage of the inventive concepts disclosed and claimed herein.

What is claimed is:

1. A method of recovering drill beads from a drilling fluid used in a drilling operation comprising the steps of:
directing drilling fluid containing a predetermined amount of drill beads having pre-selected specific gravities into a drill string positioned in a well bore, the drill beads having magnetic properties;
recovering the drilling fluid containing at least a portion of the drill beads from the well bore; and
magnetically separating the drill beads from the drilling fluid.

2. The method of claim 1, further comprising the step of:
adding the drill beads to the drilling fluid prior to the step of directing the drilling fluid containing a predetermined amount of drill beads into a drill string positioned in a well bore.

3. A drilling fluid system to be used in a drilling operation comprising:
a drill string positioned in a well bore, the drill string having a drill bit, the well bore having a bottom portion and a top portion, the drill bit operating substantially in the bottom portion of the well bore;
means for injecting drilling fluid containing a predetermined amount of drill beads into the drill string, the drill beads having magnetic properties, the drilling fluid containing the drill beads exiting the drill string from the drill bit;
means for recovering the drilling fluid containing at least a portion of the drill beads from the top portion of the well bore; and
a magnetic separator apparatus receiving the recovered drilling fluid containing at least a portion of the drill beads and separating the drill beads from the drilling fluid.

4. The drilling fluid system of claim 3, further comprising:
a drill bead storage apparatus configured to receive drill beads from the magnetic separator apparatus.

5. The drilling system of claim 3, further comprising:
a drilling fluid storage apparatus configured to receive drilling fluid from the magnetic separator apparatus.

6. A drill bead, comprising:
an outer shell shaped to reduce friction between a drill string and a casing, the outer shell constructed of a non-magnetic material; and
magnetic particles proximate to the outer shell.

7. The drill bead of claim 6, wherein the magnetic particles are within the outer shell.

8. The drill bead of claim 6, further comprising a core within the outer shell, and wherein the magnetic particles are within the core.

9. The drill bead of claim 6, wherein the outer shell defines a plurality of pockets within the outer shell, the pockets containing at least one of a liquid and a gas.

10. The drill bead of claim 6, further comprising a core within the outer shell, the core containing at least one of a liquid and a gas.

11. In combination, a drilling fluid and drill beads, in which the drilling fluid contains a predetermined amount of the drill beads within a range between 0.1 pounds per barrel and 200 pounds per barrel, the drill beads having a magnetic property, and at least one of a cylindrical and a spherical shape, a first drill bead of the drill beads having a first specific gravity, and a second drill bead of the drill beads having a second specific gravity, wherein the first specific gravity is different from the second specific gravity.

12. The combination of claim 11, wherein at least some of the drill beads comprise:
an outer shell constructed of a non-magnetic material; and
magnetic particles proximate to the outer shell.

13. The combination of claim 12, wherein the magnetic particles are within the outer shell.

14. The combination of claim 12, further comprising a core within the outer shell, and wherein the magnetic particles are within the core.

15. The combination of claim 12, wherein the outer shell defines a plurality of pockets within the outer shell, the pockets containing at least one of a liquid and a gas.

16. The combination of claim 12, further comprising a core within the outer shell, the core containing at least one of a liquid and a gas.

17. The combination of claim 12, wherein a first group of the drill beads is provided with a first specific gravity, and a second group of the drill beads is provided with a second specific gravity, the second specific gravity being greater than the first specific gravity.
